(19) United States
(12) Patent Application Publication
(10) Pub. No.: US 2021/0104740 A1
(43) Pub. Date: Apr. 8, 2021

(54) METHODS OF PRELITHIATING SILICON-CONTAINING ELECTRODES

(71) Applicant: ENEVATE CORPORATION, Irvine, CA (US)

(72) Inventors: Shiang Jen Teng, Irvine, CA (US); David J. Lee, Irvine, CA (US)

(21) Appl. No.: 16/590,781

(22) Filed: Oct. 2, 2019

(51) Int. Cl. H01M 4/38; H01M 4/40; H01M 4/134; H01M 4/1395; H01M 4/66

(52) U.S. Cl. CPC H01M 4/386; H01M 4/405; H01M 4/667; H01M 4/1395; H01M 4/134

(57) ABSTRACT

Methods for prelithiating a silicon-containing electrode or electrodes, for example in the form of an electrode roll, are described herein. A method of prelithiating a silicon-containing electrode can include electrically connecting the silicon-containing electrode to a negative terminal of an electrical power source and immersing the silicon-containing electrode in a lithium salt solution. A lithium source can be connected to a positive terminal of the electrical power source and also immersed in the lithium salt solution. A current can be applied to the silicon-containing electrode to thereby intercalate the silicon-containing electrode with lithium. The silicon-containing electrode may comprise a current collector and may subsequently be used as an anode in a lithium-ion electrochemical cell.

### BACKGROUND

### Field

The present disclosure relates to electrodes used in electrochemical cells. In particular, the present disclosure relates to methods of lithiating silicon-containing electrodes for use in electrochemical cells.

### Description of the Related Art

As the demands for both zero-emission electric vehicles and grid-based energy storage systems increase, lower costs and improvements in energy density, power density, and safety of lithium (Li)-ion batteries are highly desirable. Achieving the high energy density and safety of Li-ion batteries requires the development of high-capacity and high-voltage cathodes, high-capacity anodes, and functional electrolytes with high voltage stability, interfacial compatibility with electrodes and safety.

A lithium-ion battery typically includes a separator and/or electrolyte between an anode and a cathode. In one class of batteries, the separator, cathode and anode materials are individually formed into sheets or films. Sheets of the cathode, separator and anode are subsequently stacked or rolled with the separator separating the cathode and anode (e.g., electrodes) to form the battery. Typical electrodes include electro-chemically active material layers on electrically conductive metals (e.g., aluminum and copper). Films can be rolled or cut into pieces which are then layered into stacks. The stacks are of alternating electro-chemically active materials with the separator between them.

Si is one of the most promising anode materials for Li-ion batteries due to its high specific gravimetric and volumetric capacity (3579 mAh/g and 2194 mAh/cm³ vs. 372 mAh/g and 719 mAh/cm³ for graphite), and low lithiation potential (<0.4 V vs. Li/Li⁺). Among the various cathodes presently available, layered lithium transition-metal oxides such as Ni-rich Li[NiₓCo_{y}Mn(Al)_{1-x-y}]O₂ (NCM or NCA) are the most promising ones due to their high theoretical capacity (˜280 mAh/g) and relatively high average operating potential (3.6 V vs Li/Li⁺). In addition to Ni-rich NCM or NCA cathode, LiCoO₂ (LCO) is also a very attractive cathode material because of its relatively high theoretical specific capacity of 274 mAh g⁻¹, high theoretical volumetric capacity of 1363 mAh cm³, low self-discharge, high discharge voltage, and good cycling performance. Coupling Si anodes with high-voltage Ni-rich NCM (or NCA) or LCO cathodes can deliver more energy than conventional Li-ion batteries with graphite-based anodes, due to the high capacity of these new electrodes. However, both Si-based anodes and high-voltage Ni rich NCM (or NCA) or LCO cathodes face formidable technological challenges, and long-term cycling stability with high-Si anodes paired with NCM or NCA cathodes has yet to be achieved.

For anodes, silicon-based materials can provide significant improvement in energy density. However, the large volumetric expansion (>300%) during the Li alloying/dealloying processes can lead to disintegration of the active material and the loss of electrical conduction paths, thereby reducing the cycling life of the battery. In addition, an unstable solid electrolyte interphase (SEI) layer can develop on the surface of the cycled anodes, and leads to an endless exposure of Si particle surfaces to the liquid electrolyte. This results in an irreversible capacity loss at each cycle due to the reduction at the low potential where the liquid electrolyte reacts with the exposed surface of the Si anode. In addition, oxidative instability of the conventional non-aqueous electrolyte takes place at voltages beyond 4.5 V, which can lead to accelerated decay of cycling performance. Because of the generally inferior cycle life of Si compared to graphite, only a small amount of Si or Si alloy is used in conventional anode materials.

The NCM (or NCA) or LCO cathode usually suffers from an inferior stability and a low capacity retention at a high cut-off potential. The reasons can be ascribed to the unstable surface layer's gradual exfoliation, the continuous electrolyte decomposition, and the transition metal ion dissolution into electrolyte solution. The major limitations for LCO cathode are high cost, low thermal stability, and fast capacity fade at high current rates or during deep cycling. LCO cathodes are expensive because of the high cost of Co. Low thermal stability refers to exothermic release of oxygen when a lithium metal oxide cathode is heated. In order to make good use of Si anode//NCM or NCA cathode-, and Si anode//LCO cathode-based Li-ion battery systems, the aforementioned barriers need to be overcome.

Prelithiation of silicon is an effective way to alleviate the large volume expansion and rapid capacity fade for silicon anodes. Prelithiation involves intercalating lithium ions into the silicon prior to subjecting the electrode to a charging cycle. Known methods of prelithiation can involve dipping a web of electrochemically active material, prior to forming an electrode therefrom, in an organic salt while running a current through the web. These types of processes typically require high temperatures to drive lithiation of the active material, and can result in lithium metal plating onto the active material during the process. Other methods of prelithiation involve directly contacting electrochemically active material with lithium metal, or depositing lithium metal directly onto the active material, for example via a vapor deposition process. As these methods can include, or even require, plating of lithium or handling of metallic lithium in either particulate or film form, the resultant prelithiated active material can present safety risks due to the hazardous nature of lithium metal. The processes also require numerous extra processing steps prior to forming an electrode from the active material. Furthermore, due to the reactivity of the materials typically involved in these processes, an inert atmosphere is often required further complicating processing and scalability.

### SUMMARY

In some aspects, a method of prelithiating a silicon-containing electrode is provided. The method includes electrically connecting the silicon-containing electrode to a negative terminal of an electrical power source, immersing the silicon-containing electrode in a lithium salt solution, wherein a lithium source is immersed in the lithium salt solution such that it does not directly contact the silicon-containing electrode and the lithium source is electrically connected to a positive terminal of the electrical power source, and applying a current from the electrical power source to the silicon-containing electrode for a duration until a desired level of lithium intercalation of the silicon-containing electrode is achieved.

In some embodiments, the silicon-containing electrode comprises a film comprising silicon and a carbon phase that holds the film together. In some embodiments, the silicon-containing electrode further comprises silicon particles distributed within the carbon phase. In some embodiments, the silicon-containing electrode further comprises a current collector, the film being in electrical communication with the current collector. In some embodiments, the silicon-containing electrode is a rolled-type electrode. In some embodiments, the silicon-containing electrode comprises and anode.

In some embodiments, applying the current from the electrical power source to the silicon-containing electrode results in a current density in the silicon-containing electrode of from about 0.05 mA/cm² to about 0.5 mA/cm². In some embodiments, the lithium source comprises lithium metal. In some embodiments, the lithium source comprises lithium metal foil. In some embodiments, the lithium salt solution comprises an organic lithium salt solution. In some embodiments, the lithium salt solution comprises Li trans-trans-muconate (ttMA). In some embodiments, the method is carried out at room temperature. In some embodiments, the method is carried out in an ambient atmosphere.

In some embodiments, the method further comprises brushing the film and exposing the film to blowing air prior to immersing the silicon-containing electrode in the lithium salt solution. In some embodiments, the method further comprises subjecting the silicon-containing electrode to a post treatment process, wherein the post treatment process comprises rinsing the silicon-containing electrode with water and drying the rinsed silicon-containing electrode. In some embodiments, substantially no lithium metal is plated or deposited on the silicon-containing electrode.

In some embodiments, the prelithiated silicon-containing electrode is used as a component in a lithium-ion electrochemical cell. In some embodiments, the silicon-containing electrode is a Si-dominant electrode. In some embodiments, the silicon-containing electrode comprises a self-supporting composite material film. In some embodiments, the composite material film includes greater than 0% and less than about 90% by weight of silicon particles, and greater than 0% and less than about 90% by weight of one or more types of carbon phases, wherein at least one of the one or more types of carbon phases is a substantially continuous phase that holds the composite material film together such that the silicon particles are distributed throughout the composite material film.

### BRIEF DESCRIPTION OF THE DRAWINGS

FIG. 1 depicts a cross-sectional schematic diagram of an example of a lithium-ion battery 300 implemented as a pouch cell.

FIG. 2 illustrates a method of prelithiating a silicon-containing anode according to some embodiments.

FIG. 3 illustrates an apparatus for prelithiating a silicon-containing anode according to some embodiments.

FIG. 4 is a plot of charge and discharge capacity for the first formation cycles of silicon-containing anodes that have been prelithiated to varying percentages according to some embodiments, and pristine Si-containing anodes.

FIG. 5A is a plot of charge voltage versus capacity for silicon-containing anodes that have been prelithiated to varying percentages according to some embodiments, and pristine Si-containing anodes.

FIG. 5B is a plot of discharge voltage versus capacity for silicon-containing anodes that have been prelithiated to varying percentages according to some embodiments, and pristine Si-containing anodes.

FIG. 6 is a plot of the change in charge capacity divided by the change in voltage versus voltage for silicon-containing anodes that have been prelithiated to varying percentages according to some embodiments, and pristine Si-containing anodes.

### DETAILED DESCRIPTION

### Description

When a rechargeable lithium-ion cell is charging, the cathode releases lithium ions that move through the electrolyte to the anode. The lithium-ion cell stores these lithium ions in the electrochemically active material of the anode during this process. When the lithium-ion cell is discharging, the stored lithium ions move back across the electrolyte to the cathode and release the stored energy. However, the release of the lithium ions from the silicon-containing anode to the cathode during discharging does not fully recover the cathode. This phenomenon can be referred to as the coulombic efficiency (CE) of the electrochemical cell, and can be used to verify the effectiveness of a lithium-ion battery. The coulombic efficiency of a lithium-ion cell is not perfect. For example, a lithium-ion cell with a CE of 0.999 and including a graphite anode can only be operated for about 1000 cycles. Prelithiating the silicon-containing electrodes before assembling the electrochemical cell may not only provide more lithium to be stored in the electrodes, thus improving its coulombic efficiency, but may also suppress the silicon-containing electrodes' chemical potential so that more lithium ions are transferred during discharge. In addition, the excess amount of lithium ions in the silicon-containing electrode can alleviate the large volume expansion and rapid capacity fade experienced by silicon-containing electrodes that have not been prelithiated.

This application describes a new method of prelithiating silicon-containing electrodes, for example silicon-containing anodes, using a lithium salt solution, an electrical power source, and a lithium source. The prelithiation processes described herein can be utilized in large-scale industrial battery fabrication. One or more silicon-containing anodes, for example, in the form of an anode roll may be prelithiated simultaneously. In some embodiments, methods of prelithiating silicon-containing electrodes can comprise prelithiating a roll of silicon-containing electrodes, for example silicon-containing anodes. In some embodiments, the silicon-containing anodes may comprise a silicon-containing composite material and a current collector comprising, for example, copper. In some embodiments, the silicon-containing anodes may be laminated on the current collectors. In some embodiments, the roll of silicon anodes may be electrically connected to the negative terminal of an electrical power source, while a lithium source, for example lithium metal foil, can be electrically connected to the positive terminal of the electrical power source. The roll of silicon-containing anodes and lithium source may be immersed in a lithium salt solution. Electrical current may be generated by the electrical power source and applied to the silicon-containing anodes, which acts as negative electrode, while the lithium source acts as a positive electrode.

The lithium ions in the lithium salt solution are attracted to the negatively charged silicon-containing anode roll and intercalate themselves into the silicon-containing anodes. The concentration of lithium in the lithium salt solution can be selected in order to achieve a desired level of lithium intercalation into the silicon-containing anode. In some embodiments, this prelithiation process may provide homogenous lithium intercalation throughout the entire thickness, or depth of the silicon-containing anodes.

The amount of lithium intercalation into, or prelithiation of, the-anodes may also be finely controlled by controlling the strength of the current applied to the silicon-containing anode by the electrical power source. Accordingly, the current density for the silicon-containing anodes determines the lithium intercalation rate for the silicon-containing anode surface. As the current density is increased, the lithium intercalation rate correspondingly increases. However, the current density also affects the lithium intercalation depth, that is, the depth to which lithium ions are able to intercalate into the silicon-containing anodes. As the current density is increased, the intercalation depth correspondingly decreases, potentially resulting in a lack of lithium intercalation throughout the entire thickness of the silicon-containing anodes. Thus, there is an optimal level of current density which can be readily determined by the skilled artisan in order to satisfy the desired amount of prelithiation and desired prelithiation depth that a prelithiation silicon-containing anode requires.

In some embodiments the silicon-containing anode may be subjected to an optional pretreatment process, and/or post-treatment process. In some embodiments, the pretreatment process may comprise cleaning the surface of the silicon-containing anode, for example by mechanical brushing and/or blowing high-pressure air thereon. In some embodiments, the pretreatment process may eliminate or substantially reduce the amount of contaminants on the surface of a silicon-containing anode. In some embodiments, a silicon-containing anode may be subjected to a pretreatment process before, during, or after being laminated to a current collector. In some embodiments, an optional post-treatment process may comprise rinsing a prelithiated silicon-containing anode with water and subsequently drying the silicon-containing anode. In some embodiments, the post-treatment process may comprise repeating the rinsing and drying steps one or more times.

After the silicon-containing anodes have be prelithiated and subjected to any optional post-treatment processes, the anodes may further processed to form a battery electrode for a lithium-ion battery assembly. For example, after prelithiation the silicon-containing anodes may be punched into individual silicon-containing anodes for use in a lithium-ion battery assembly.

Typical carbon anode electrodes include a current collector such as a copper sheet. Carbon is deposited onto the collector along with an inactive binder material. Carbon is often used because it has excellent electrochemical properties and is also electrically conductive. If the current collector layer (e.g., copper layer) was removed, the carbon would likely be unable to mechanically support itself. Therefore, conventional electrodes require a support structure such as the collector to be able to function as an electrode. The electrode (e.g., anode or cathode) compositions described in this application can produce electrodes that are self-supported. The need for a metal foil current collector is eliminated or minimized because conductive carbonized polymer is used for current collection in the anode structure as well as for mechanical support. In typical applications for the mobile industry, a metal current collector is typically added to ensure sufficient rate performance. The carbonized polymer can form a substantially continuous conductive carbon phase in the entire electrode as opposed to particulate carbon suspended in a non-conductive binder in one class of conventional lithium-ion battery electrodes. Advantages of a carbon composite blend that utilizes a carbonized polymer can include, for example, 1) higher capacity, 2) enhanced overcharge/discharge protection, 3) lower irreversible capacity due to the elimination (or minimization) of metal foil current collectors, and 4) potential cost savings due to simpler manufacturing.

Anode electrodes currently used in the rechargeable lithium-ion cells typically have a specific capacity of approximately 200 milliamp hours per gram (including the metal foil current collector, conductive additives, and binder material). Graphite, the active material used in most lithium-ion battery anodes, has a theoretical energy density of 372 milliamp hours per gram (mAh/g). In comparison, silicon has a high theoretical capacity of about 4200 mAh/g. In order to increase volumetric and gravimetric energy density of lithium-ion batteries, silicon may be used as the active material for the cathode or anode. Several types of silicon materials, e.g., silicon nanopowders, silicon nanofibers, porous silicon, and ball-milled silicon, have also been reported as viable candidates as active materials for the negative or positive electrodes. Small particle sizes (for example, sizes in the nanometer range) generally can increase cycle life performance. They also can display very high initial irreversible capacity. However, small particle sizes also can result in very low volumetric energy density (for example, for the overall cell stack) due to the difficulty of packing the active material. Larger particle sizes, (for example, sizes in the micron range) generally can result in higher density anode material. However, the expansion of the silicon active material can result in poor cycle life due to particle cracking. For example, silicon can swell in excess of 300% upon lithium insertion. Because of this expansion, anodes including silicon should be allowed to expand while maintaining electrical contact between the silicon particles.

Cathode electrodes described herein may include metal oxide cathode materials, such as Lithium Cobalt Oxide (LiCoO₂) (LCO), Ni-rich oxides, high voltage cathode materials, lithium-rich oxides, nickel-rich layered oxides, lithium rich layered oxides, high-voltage spinel oxides, and high-voltage polyanionic compounds. Ni-rich oxides and/or high voltage cathode materials may include NCM and NCA. One example of a NCM material includes LiNi_{0.6}Co_{0.2}Mn_{0.2}O₂ (NCM-622). Lithium rich oxides may include xLi₂Mn₃O₂.(1−x)LiNiₐCo_{b}Mn_{c}O₂. Nickel-rich layered oxides may include LiNi₁₊ₓM₁₋ₓO_{z} (where M=Co, Mn or Al). Lithium rich layered oxides may include LiNi₁₊ₓM₁₋ₓO₂ (where M=Co, Mn or Ni). High-voltage spinel oxides may include LiNi_{0.5}Mn_{1.5}O₄. High-voltage polyanionic compounds may include phosphates, sulfates, silicates, etc.

As described herein and in U.S. patent application Ser. Nos. 13/008,800 and 13/601,976, entitled “Composite Materials for Electrochemical Storage” and “Silicon Particles for Battery Electrodes,” respectively, certain embodiments utilize a method of creating monolithic, self-supported anodes using a carbonized polymer. Because the polymer is converted into an electrically conductive and electrochemically active matrix, the resulting electrode is conductive enough that, in some embodiments, a metal foil or mesh current collector can be omitted or minimized. The converted polymer also acts as an expansion buffer for silicon particles during cycling so that a high cycle life can be achieved. In certain embodiments, the resulting electrode is an electrode that is comprised substantially of active material. In further embodiments, the resulting electrode is substantially active material. The electrodes can have a high energy density of between about 500 mAh/g to about 1200 mAh/g that can be due to, for example, 1) the use of silicon, 2) elimination or substantial reduction of metal current collectors, and 3) being comprised entirely or substantially entirely of active material.

As described herein and in U.S. patent application Ser. No. 14/800,380, entitled “Electrolyte Compositions for Batteries,” the entirety of which is hereby incorporated by reference, composite materials can be used as an anode in most conventional Li-ion batteries; they may also be used as the cathode in some electrochemical couples with additional additives. The composite materials can also be used in either secondary batteries (e.g., rechargeable) or primary batteries (e.g., non-rechargeable). In some embodiments, the composite materials can be used in batteries implemented as a pouch cell, as described in further details herein. In certain embodiments, the composite materials are self-supported structures. In further embodiments, the composite materials are self-supported monolithic structures. For example, a collector may be included in the electrode comprised of the composite material. In certain embodiments, the composite material can be used to form carbon structures discussed in U.S. patent application Ser. No. 12/838,368 entitled “Carbon Electrode Structures for Batteries,” the entirety of which is hereby incorporated by reference. Furthermore, the composite materials described herein can be, for example, silicon composite materials, carbon composite materials, and/or silicon-carbon composite materials.

In some embodiments, a largest dimension of the silicon particles can be less than about 40 μm, less than about 1 μm, between about 10 nm and about 40 μm, between about 10 nm and about 1 μm, less than about 500 nm, less than about 100 nm, and about 100 nm. All, substantially all, or at least some of the silicon particles may comprise the largest dimension described above. For example, an average or median largest dimension of the silicon particles can be less than about 40 μm, less than about 1 μm, between about 10 nm and about 40 μm, between about 10 nm and about 1 μm, less than about 500 nm, less than about 100 nm, and about 100 nm. The amount of silicon in the composite material can be greater than zero percent by weight of the mixture and composite material. In certain embodiments, the mixture comprises an amount of silicon, the amount being within a range of from about 0% to about 90% by weight, including from about 30% to about 80% by weight of the mixture. The amount of silicon in the composite material can be within a range of from about 0% to about 35% by weight, including from about 0% to about 25% by weight, from about 10% to about 35% by weight, and about 20% by weight. In further certain embodiments, the amount of silicon in the mixture is at least about 30% by weight. Additional embodiments of the amount of silicon in the composite material include more than about 50% by weight, between about 30% and about 80% by weight, between about 50% and about 70% by weight, and between about 60% and about 80% by weight. Furthermore, the silicon particles may or may not be pure silicon. For example, the silicon particles may be substantially silicon or may be a silicon alloy. In one embodiment, the silicon alloy includes silicon as the primary constituent along with one or more other elements.

As described herein, micron-sized silicon particles can provide good volumetric and gravimetric energy density combined with good cycle life. In certain embodiments, to obtain the benefits of both micron-sized silicon particles (e.g., high energy density) and nanometer-sized silicon particles (e.g., good cycle behavior), silicon particles can have an average particle size in the micron range and a surface including nanometer-sized features. In some embodiments, the silicon particles have an average particle size (e.g., average diameter or average largest dimension) between about 0.1 μm and about 30 μm or between about 0.1 μm and all values up to about 30 μm. For example, the silicon particles can have an average particle size between about 0.5 μm and about 25 μm, between about 0.5 μm and about 20 μm, between about 0.5 μm and about 15 μm, between about 0.5 μm and about 10 μm, between about 0.5 μm and about 5 μm, between about 0.5 μm and about 2 μm, between about 1 μm and about 20 μm, between about 1 μm and about 15 μm, between about 1 μm and about 10 μm, between about 5 μm and about 20 μm, etc. Thus, the average particle size can be any value between about 0.1 μm and about 30 μm, e.g., 0.1 μm, 0.5 μm, 1 μm, 5 μm, 10 μm, 15 μm, 20 μm, 25 μm, and 30 μm.

The composite material can be formed by pyrolyzing a polymer precursor, such as polyamide acid. The amount of carbon obtained from the precursor can be about 50 weight percent by weight of the composite material. In certain embodiments, the amount of carbon from the precursor in the composite material is about 10% to about 25% by weight. The carbon from the precursor can be hard carbon. Hard carbon can be a carbon that does not convert into graphite even with heating in excess of 2800 degrees Celsius. Precursors that melt or flow during pyrolysis convert into soft carbons and/or graphite with sufficient temperature and/or pressure. Hard carbon may be selected since soft carbon precursors may flow and soft carbons and graphite are mechanically weaker than hard carbons. Other possible hard carbon precursors can include phenolic resins, epoxy resins, and other polymers that have a very high melting point or are crosslinked. In some embodiments, the amount of hard carbon in the composite material has a value within a range of from about 10% to about 25% by weight, about 20% by weight, or more than about 50% by weight. In certain embodiments, the hard carbon phase is substantially amorphous. In other embodiments, the hard carbon phase is substantially crystalline. In further embodiments, the hard carbon phase includes amorphous and crystalline carbon. The hard carbon phase can be a matrix phase in the composite material. The hard carbon can also be embedded in the pores of the additives including silicon. The hard carbon may react with some of the additives to create some materials at interfaces. For example, there may be a silicon carbide layer between silicon particles and the hard carbon.

In certain embodiments, graphite particles are added to the mixture. Advantageously, graphite can be an electrochemically active material in the battery as well as an elastic deformable material that can respond to volume change of the silicon particles. Graphite is the preferred active anode material for certain classes of lithium-ion batteries currently on the market because it has a low irreversible capacity. Additionally, graphite is softer than hard carbon and can better absorb the volume expansion of silicon additives. In certain embodiments, a largest dimension of the graphite particles is between about 0.5 microns and about 20 microns. All, substantially all, or at least some of the graphite particles may comprise the largest dimension described herein. In further embodiments, an average or median largest dimension of the graphite particles is between about 0.5 microns and about 20 microns. In certain embodiments, the mixture includes greater than 0% and less than about 80% by weight of graphite particles. In further embodiments, the composite material includes about 40% to about 75% by weight graphite particles.

In certain embodiments, conductive particles which may also be electrochemically active are added to the mixture. Such particles can enable both a more electronically conductive composite as well as a more mechanically deformable composite capable of absorbing the large volumetric change incurred during lithiation and de-lithiation. In certain embodiments, a largest dimension of the conductive particles is between about 10 nanometers and about 7 millimeters. All, substantially all, or at least some of the conductive particles may comprise the largest dimension described herein. In further embodiments, an average or median largest dimension of the conductive particles is between about 10 nm and about 7 millimeters. In certain embodiments, the mixture includes greater than zero and up to about 80% by weight conductive particles. In further embodiments, the composite material includes about 45% to about 80% by weight conductive particles. The conductive particles can be conductive carbon including carbon blacks, carbon fibers, carbon nanofibers, carbon nanotubes, graphite, graphene, etc. Many carbons that are considered as conductive additives that are not electrochemically active become active once pyrolyzed in a polymer matrix. Alternatively, the conductive particles can be metals or alloys including copper, nickel, or stainless steel.

The composite material may also be formed into a powder. For example, the composite material can be ground into a powder. The composite material powder can be used as an active material for an electrode. For example, the composite material powder can be deposited on a collector in a manner similar to making a conventional electrode structure, as known in the industry.

In some embodiments, the full capacity of the composite material may not be utilized during use of the battery to improve battery life (e.g., number charge and discharge cycles before the battery fails or the performance of the battery decreases below a usability level). For example, a composite material with about 70% by weight silicon particles, about 20% by weight carbon from a precursor, and about 10% by weight graphite may have a maximum gravimetric capacity of about 2000 mAh/g, while the composite material may only be used up to a gravimetric capacity of about 550 to about 850 mAh/g. Although, the maximum gravimetric capacity of the composite material may not be utilized, using the composite material at a lower capacity can still achieve a higher capacity than certain lithium ion batteries. In certain embodiments, the composite material is used or only used at a gravimetric capacity below about 70% of the composite material's maximum gravimetric capacity. For example, the composite material is not used at a gravimetric capacity above about 70% of the composite material's maximum gravimetric capacity. In further embodiments, the composite material is used or only used at a gravimetric capacity below about 50% of the composite material's maximum gravimetric capacity or below about 30% of the composite material's maximum gravimetric capacity.

### Electrolyte

An electrolyte for a lithium ion battery can include a solvent and a lithium ion source, such as a lithium-containing salt. The composition of the electrolyte may be selected to provide a lithium ion battery with improved performance. In some embodiments, the electrolyte may contain an electrolyte additive. As described herein, a lithium ion battery may include a first electrode, a second electrode, a separator between the first electrode and the second electrode, and an electrolyte in contact with the first electrode, the second electrode, and the separator. The electrolyte serves to facilitate ionic transport between the first electrode and the second electrode. In some embodiments, the first electrode and the second electrode can refer to anode and cathode or cathode and anode, respectively.

In some embodiments, the electrolyte for a lithium ion battery may include a solvent comprising a fluorine-containing component, such as a fluorine-containing cyclic carbonate, a fluorine-containing linear carbonate, and/or a fluoroether. In some embodiments, the electrolyte can include more than one solvent. For example, the electrolyte may include two or more co-solvents. In some embodiments, at least one of the co-solvents in the electrolyte is a fluorine-containing compound. In some embodiments, the fluorine-containing compound may be fluoroethylene carbonate (FEC), 1,1,2,2-tetrafluoroethyl 2,2,3,3-tetrafluoropropyl ether, or difluoroethylene carbonate (F2EC). In some embodiments, the co-solvent may be selected from the group consisting of FEC, ethyl methyl carbonate (EMC), 1,1,2,2-tetrafluoroethyl 2,2,3,3-tetrafluoropropyl ether, difluoroethylene carbonate (F2EC), ethylene carbonate (EC), diethyl carbonate (DEC), dimethyl carbonate (DMC), propylene carbonate (PC), and gamma-Butyrolactone (GBL). In some embodiments, the electrolyte contains FEC. In some embodiments, the electrolyte contains both EMC and FEC. In some embodiments, the electrolyte may further contain 1,1,2,2-tetrafluoroethyl 2,2,3,3-tetrafluoropropyl ether, EC, DEC, DMC, PC, GBL, and/or F2EC or some partially or fully fluorinated linear or cyclic carbonates, ethers, etc. as a co-solvent. In some embodiments, the electrolyte is free or substantially free of non-fluorine-containing cyclic carbonates, such as EC, GBL, and PC.

As used herein, a co-solvent of an electrolyte has a concentration of at least about 10% by volume (vol %). In some embodiments, a co-solvent of the electrolyte may be about 20 vol %, about 40 vol %, about 60 vol %, or about 80 vol %, or about 90 vol % of the electrolyte. In some embodiments, a co-solvent may have a concentration from about 10 vol % to about 90 vol %, from about 10 vol % to about 80 vol %, from about 10 vol % to about 60 vol %, from about 20 vol % to about 60 vol %, from about 20 vol % to about 50 vol %, from about 30 vol % to about 60 vol %, or from about 30 vol % to about 50 vol %.

For example, in some embodiments, the electrolyte may contain a fluorine-containing cyclic carbonate, such as FEC, at a concentration of about 10 vol % to about 60 vol %, including from about 20 vol % to about 50 vol %, and from about 20 vol % to about 40 vol %. In some embodiments, the electrolyte may comprise a linear carbonate that does not contain flourine, such as EMC, at a concentration of about 40 vol % to about 90 vol %, including from about 50 vol % to about 80 vol %, and from about 60 vol % to about 80 vol %. In some embodiments, the electrolyte may comprise 1,1,2,2-tetrafluoroethyl 2,2,3,3-tetrafluoropropyl ether at a concentration of from about 10 vol % to about 30 vol %, including from about 10 vol % to about 20 vol %.

In some embodiments, the electrolyte is substantially free of cyclic carbonates other than fluorine-containing cyclic carbonates (i.e., non-fluorine-containing cyclic carbonates). Examples of non-fluorine-containing carbonates include EC, PC, GBL, and vinylene carbonate (VC).

### Electrolyte Additives

In some embodiments, the electrolyte may further comprise one or more additives. As used herein, an additive of the electrolyte refers to a component that makes up less than 10% by weight (wt %) of the electrolyte. In some embodiments, the amount of each additive in the electrolyte may be from about 0.2 wt % to about 1 wt %, 0.1 wt % to about 2 wt %, 0.2 wt % to about 9 wt %, from about 0.5 wt % to about 9 wt %, from about 1 wt % to about 9 wt %, from about 1 wt % to about 8 wt %, from about 1 wt % to about 8 wt %, from about 1 wt % to about 7 wt %, from about 1 wt % to about 6 wt %, from about 1 wt % to about 5 wt %, from about 2 wt % to about 5 wt %, or any value in between. In some embodiments, the total amount of the additive(s) may be from about 1 wt % to about 9 wt %, from about 1 wt % to about 8 wt %, from about 1 wt % to about 7 wt %, from about 2 wt % to about 7 wt %, or any value in between.

### Energy Storage Device

The methods and apparatuses described herein may be advantageously utilized within an energy storage device. In some embodiments, energy storage devices may include batteries, capacitors, and battery-capacitor hybrids. In some embodiments, the energy storage device comprise lithium. In some embodiments, the energy storage device may comprise at least one electrode, such as an anode and/or cathode. In some embodiments, at least one electrode may be a Si-based electrode. In some embodiments, the Si-based electrode is a Si-dominant electrode, where silicon is the majority of the active material used in the electrode (e.g., greater than 50% silicon). In some embodiments, the energy storage device comprises a separator. In some embodiments, the separator is between a first electrode and a second electrode. In some embodiments, the electrode may be prelithiated as described by the methods and by the apparatuses herein.

### Pouch Cell

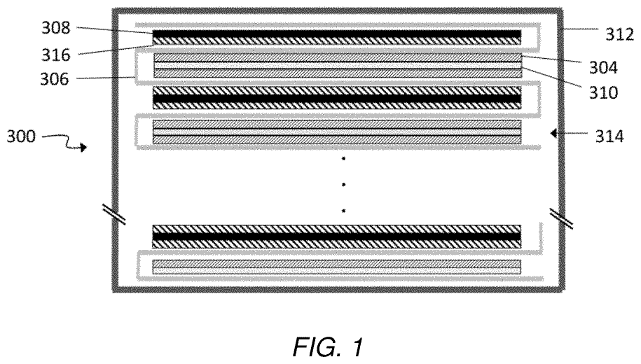

As described herein, a battery can be implement as a pouch cell. FIG. 1 shows a cross-sectional schematic diagram of an example of a lithium ion battery 300 implemented as a pouch cell, according to some embodiments. The battery 300 comprises an anode 316 in contact with a negative current collector 308, a cathode 304 in contact with a positive current collector 310, a separator 306 disposed between the anode 316 and the cathode 304. In some embodiments, a plurality of anodes 316 and cathode 304 may be arranged into a stacked configuration with a separator 306 separating each anode 316 and cathode 304. Each negative current collector 308 may have one anode 316 attached to each side; each positive current collector 310 may have one cathode 304 attached to each side. The stacks are immersed in an electrolyte 314 and enclosed in a pouch 312. The anode 302 and the cathode 304 may comprise one or more respective electrode films formed thereon. The number of electrodes of the battery 300 may be selected to provide desired device performance.

With further reference to FIG. 1, the separator 306 may comprise a single continuous or substantially continuous sheet, which can be interleaved between adjacent electrodes of the electrode stack. For example, the separator 306 may be shaped and/or dimensioned such that it can be positioned between adjacent electrodes in the electrode stack to provide desired separation between the adjacent electrodes of the battery 300. The separator 306 may be configured to facilitate electrical insulation between the anode 302 and the cathode 304, while permitting ionic transport between the anode 302 and the cathode 304. In some embodiments, the separator 306 may comprise a porous material, including a porous polyolefin material.

The lithium ion battery 300 may include an electrolyte 314, for example an electrolyte having a composition as described herein. The electrolyte 314 is in contact with the anode 302, the cathode 304, and the separator 306.

With continued reference to FIG. 1, the anode 302, cathode 304 and separator 306 of the lithium ion battery 300 may be enclosed in a housing comprising a pouch 312. In some embodiments, the pouch 312 may comprise a flexible material. For example, the pouch 312 may readily deform upon application of pressure on the pouch 312, including pressure exerted upon the pouch 312 from within the housing. In some embodiments, the pouch 312 may comprise aluminum. For example, the pouch 312 may comprise a laminated aluminum pouch.

In some embodiments, the lithium ion battery 300 may comprise an anode connector (not shown) and a cathode connector (not shown) configured to electrically couple the anodes and the cathodes of the electrode stack to an external circuit, respectively. The anode connector and a cathode connector may be affixed to the pouch 312 to facilitate electrical coupling of the battery 300 to an external circuit. The anode connector and the cathode connector may be affixed to the pouch 312 along one edge of the pouch 312. The anode connector and the cathode connector can be electrically insulated from one another, and from the pouch 312. For example, at least a portion of each of the anode connector and the cathode connector can be within an electrically insulating sleeve such that the connectors can be electrically insulated from one another and from the pouch 312.

### Prelithiation

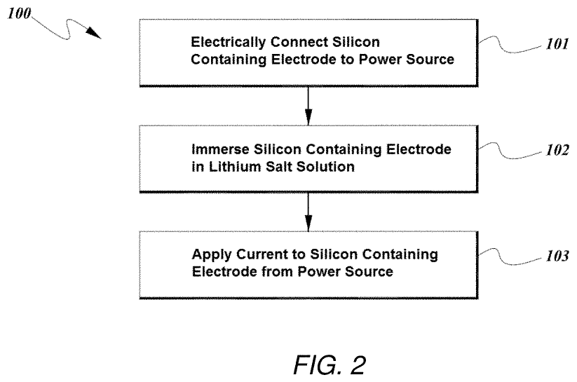

FIG. 2 illustrates one embodiment of a method of prelithiating a silicon-containing electrode or electrodes 100. The method 100 comprises electrically connecting a silicon-containing electrode to the negative terminal of an electrical power source at block 101. The silicon-containing electrode or electrodes may be electrically connected to the power source by any method known in the art or developed in the future, for example by directly connecting leads from the power source to the silicon-containing electrode and/or a current collector in electrical communication with the silicon-containing electrode.

The method 100 further comprises immersing the silicon-containing electrode in a lithium salt solution 102. In some embodiments the lithium salt solution may comprise a lithium salt dissolved in a solvent. In some embodiments the solvent may be an organic solvent. In some embodiments the lithium salt may comprise an organic lithium salt. For example, in some embodiments the lithium salt may comprise Li trans-trans-muconate (Li₂C₆H₄O₄, ttMA), Lithium oxalate (C₂Li₂O₄), Lithium fumarate (C₄H₂Li₂O₄), Maleic acid, and/or a lithium salt (e.g. C₄H₂Li₂O₄).

In some embodiments a lithium source is electrically connected to a positive terminal of the electrical power supply and is immersed in the lithium salt solution with the electrode. In some embodiments, the electrode is a wound electrode in roll form. Accordingly, the lithium source can be in electrical communication with the silicon-containing electrode via the lithium salt solution. In some embodiments the lithium source does not directly contact the silicon-containing electrode. The lithium source comprises lithium. In some embodiments the lithium source may comprise lithium in the form of lithium foil. In some embodiments more than one lithium source may be utilized, for example two or more lithium sources may be electrically connected to the positive terminals of an electrical power source and immersed in the lithium salt solution. In some embodiments, the solvent may be an organic solvent. In some embodiments, the lithium salt may comprise an organic lithium salt. For example, in some embodiments the organic lithium salt may comprise Lithium oxalate (C₂Li₂O₄), Lithium fumarate (C₄H₂Li₂O₄), Maleic acid, and/or a lithium salt (e.g. C₄H₂Li₂O₄). In some embodiments the lithium salt may comprise an inorganic lithium salt. For example, in some embodiments the lithium salt may comprise LiPF6, LiBF4, LiBOB, LiDFOB, and/or LiTFSI.

The method 100 further comprises applying a current from the electrical power source to the silicon-containing electrode 103. As the silicon-containing electrode is electrically connected to the negative terminal of the power source and the lithium source is electrically connected to the positive terminal, the silicon-containing electrode acts as a negative electrode in the system while the lithium source acts as a positive electrode and the lithium salt solution acts as an electrolyte in the system. Accordingly, while current is being applied to the silicon-containing electrode the positively charged lithium ions present in the lithium salt solution are attracted to the negative electrode. In some embodiments, lithium ions present in the lithium salt solution intercalate into the silicon-containing electrode when electrical current is applied thereto. Electrical current may be applied to the silicon-containing electrode for a duration of time until a desired level of lithium intercalation, or prelithiation, has been achieved in the silicon-containing electrode. That is, current may be applied to the silicon-containing electrode until a desired amount of lithium ions have intercalated into the silicon-containing electrode.

In some embodiments, an amount or level of prelithiation of an electrode may be defined as the percentage of silicon in the silicon-containing electrode that is alloyed with lithium during a prelithiation process. In some embodiments the methods described herein may be able to achieve prelithiation levels of greater than 4%, greater than 8%, greater than 12%, greater than 20%, greater than 25%, or greater. In some embodiments the methods described herein may be able to achieve prelithiation levels of or of about 2%, about 4%, about 5%, about 10%, about 15%, about 20%, about 25%, about 30%, about 35%, about 40%, or any range of values therebetween, for example such as about 10% to about 30%. In some embodiments a desired level of prelithiation may be achieved in a silicon-containing electrode by applying current to the silicon-containing electrode for a suitable duration of time, as can be readily determined by the skilled artisan. In some embodiments, substantially no lithium metal is plated onto the silicon-containing electrode during the prelithiation method 100. Thus, the resultant prelithiated silicon-containing electrode does not substantially comprise plated lithium metal. As there is substantially no lithium plated onto the prelithiated silicon-containing electrode, precautions do not need to be taken to prevent lithium metal from reacting with the ambient environment, and silicon-containing electrodes prelithiated according to the methods described herein may not require additional safety steps or procedures for subsequent processing as compared to silicon-containing electrodes that have not been prelithiated.

In some embodiments, prelithiation of the silicon-containing electrode may be homogenous, that is the level of prelithiation of the silicon-containing electrode remains substantially consistent throughout the entire thickness or depth of the silicon-containing electrode. In some embodiments, prelithiation of the silicon-containing electrode is performed to a certain depth or thickness. This prelithiation depth or prelithiation thickness may be controlled by controlling the current density in the silicon-containing electrode during the prelithiation process. In some embodiments, a higher current, and thus a higher current density, may be applied to the silicon-containing electrode to achieve a shallower prelithiation depth profile as can be readily determined by the skilled artisan. Additionally, the current density in the silicon-containing electrode corresponds to the speed or rate at which lithium intercalation occurs in the silicon-containing electrode. In some embodiments, the current applied to the silicon-containing electrode may be high enough to prelithiate the electrode quickly, while still achieving a desired prelithiation depth profile. A suitable current, and thus current density, can be readily determined by the skilled artisan. For example, in some embodiments a current density of or of about 0.01 mAh/cm², 0.02 mAh/cm², 0.03 mAh/cm², 0.04 mAh/cm², 0.05 mAh/cm², 0.06 mAh/cm², 0.08 mAh/cm², 0.1 mAh/cm², 0.15 mAh/cm², 0.2 mAh/cm², 0.25 mAh/cm², 0.3 mAh/cm², 0.35 mAh/cm², 0.4 mAh/cm², 0.45 mAh/cm², 0.5 mAh/cm², 0.6 mAh/cm², 0.7 mAh/cm², 0.8 mAh/cm², 0.9 mAh/cm², 1 mAh/cm², or any range of values therebetween, for example such as about 0.05 mAh/cm² to about 0.5 mAh/cm². In some embodiments, a silicon-containing electrode can have a current density of during the prelithiation processes described herein.

In some embodiments, the prelithiation method or process 100 may be carried out at room or ambient temperature. That is, in some embodiments the lithium ion salt solution is not heated. In some embodiments the prelithiation method 100 may be carried out at between about 20° C. and about 30° C. In some embodiments, the prelithiation method 100 may be carried out in an ambient atmosphere. That is, in some embodiments the prelithiation method 100 is not carried out in an inert atmosphere, as is required for some other methods of prelithiating electrodes.

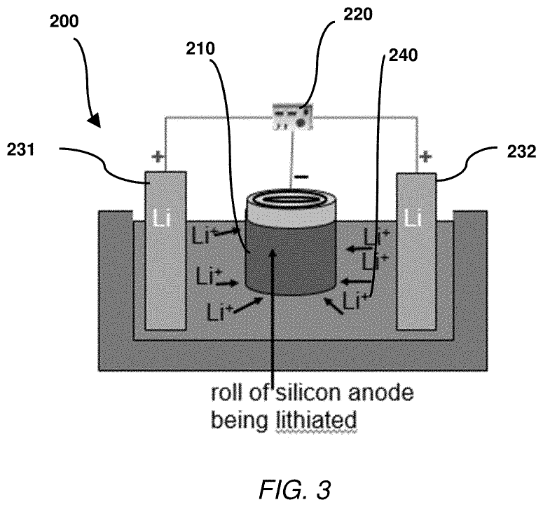

FIG. 3 illustrates one embodiment of an apparatus 200 configured for prelithiating a silicon-containing anode roll 210. As described above with respect to FIG. 3, the silicon-containing anode roll 210 is electrically connected to a negative terminal of an electrical power source 220. Apparatus 200 comprises two lithium sources 231 and 232 that are electrically connected to a positive terminal of the electrical power source 220. The silicon-containing anode roll 210 and the lithium sources 231 and 232 are immersed in a lithium salt solution 240 and a current is applied, as described above with respect to FIG. 3. FIG. 3 diagrammatically shows lithium ions (Li+) in solution moving from the lithium sources 231, 232 to the silicon-containing anode roll 210, whereupon the lithium ions are intercalated into the silicon-containing anode roll 210 to form the prelithiated silicon-containing anode roll.

In some embodiments, a silicon-containing electrode to be subjected to a prelithiation process as described herein may also include a film with an electrochemically active material on both sides of the current collector. In some embodiments, a first electrode attachment substance may be sandwiched between a first film with an electrochemically active material and a first side of the current collector, and a second electrode attachment substance may be sandwiched between a second film with an electrochemically active material and a second side of the current collector. In some embodiments, the second electrode attachment substance may be in a substantially solid state. In some embodiments, the first electrode attachment substance and the second electrode attachment substance may be chemically the same. In some embodiments, the first and second electrode attachment substances may chemically different from each other.

### Examples

Example silicon-containing electrodes were prelithiated by the prelithiation methods described herein and according to some embodiments.

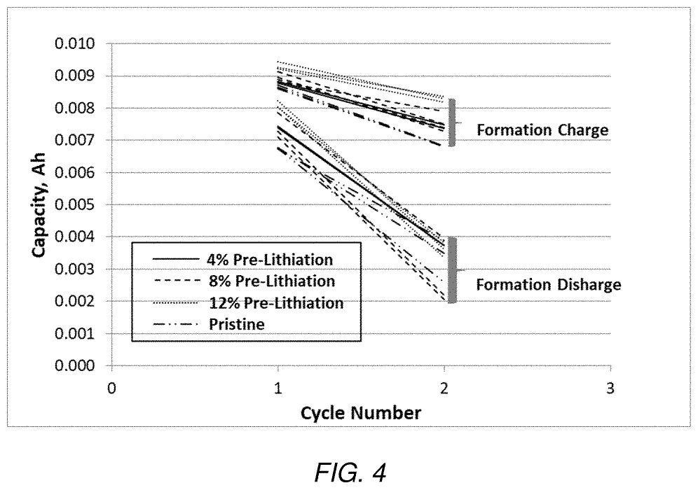

A silicon-containing electrode was not prelithiated and used as a control (pristine electrode). Silicon-containing electrodes were prelithiated to a 4% prelithiation level, an 8% prelithiation level, and a 12% prelithiation. The target percentage of prelithiation was calculated based on the non-prelithiated anode capacity and it was 17.1 mAh or 9.66mAh/cm². Then, amount of Lithium was calculated based on its specific capacity (mAh/g). For example, to make a 4% prelithiated anodeiation, 0.68 mAh of capacity was necessary from the Li chip and 0.176 mg of Li chip was prepared based on its theoretical specific capacity (3860 mAh/g of Li). Li metal was rolled in between two rollers to make a thin film and cut out desired area for control amount. The charge and discharge capacity of each sample silicon-containing electrode, pristine and prelithiated, were measured for the first formation cycle as shown in FIG. 4. As can be seen, a higher prelithiation level corresponded to a larger charge and discharge capacity, with the prelithiated sample silicon-containing electrodes all having higher charge and discharge capacities than the silicon-containing electrode that was not prelithiated. Additionally, the Coulombic Efficiency (CE) for the first formation cycle of each of the sample silicon-containing electrodes was measured, as shown in Table 1. The CE of the silicon-containing electrodes increased with increasing prelithiation levels, with the prelithiated sample silicon-containing electrodes all having higher CE's than the silicon-containing electrode sample that was not prelithiated.

TABLE 1
First Formation Cycle Coulombic Efficiency (CE) for Silicon-
containing Anodes with Varying Prelithiation Levels

| | 0% | 4% | 8% | 12% |
|---|---|---|---|---|
| | Prelithiation | Prelithiation | Prelithiation | Prelithiation |
| CE (First | 78% | 82% | 83% | 87% |
| Formation | | | | |
| Cycle) | | | | |

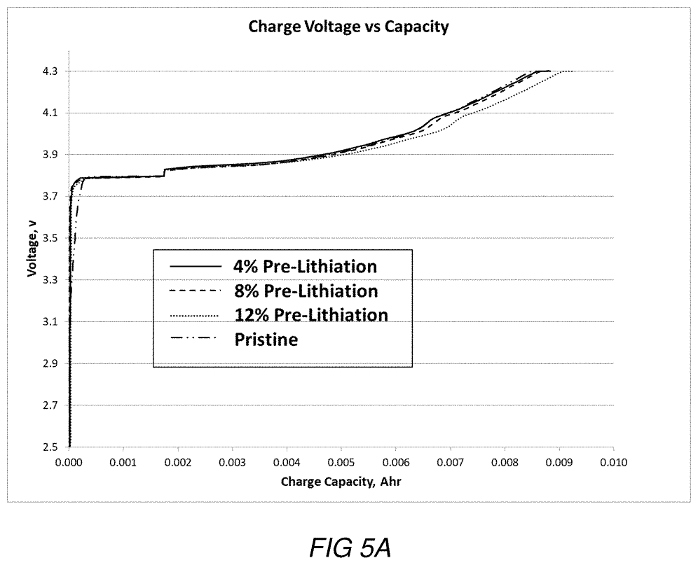

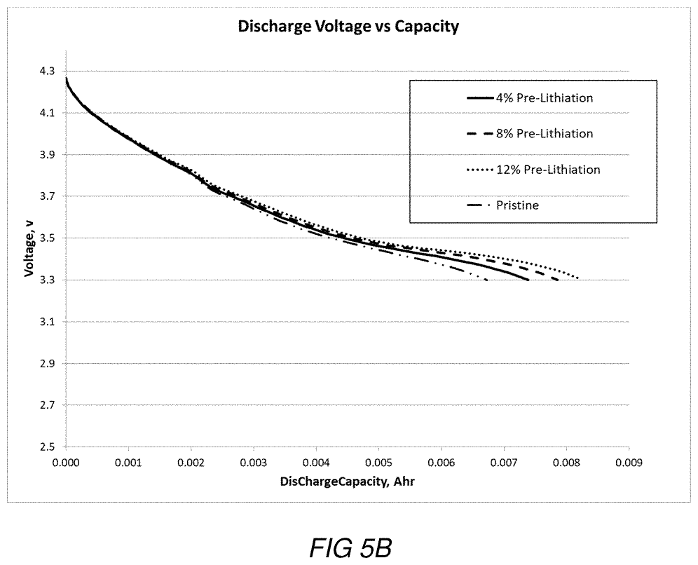

The charge and discharge voltages for the sample silicon-containing electrodes was also measured and plotted against capacity, as shown in FIGS. 5A and 5B. As can be seen in FIGS. 5A and 5B, the voltage profiles of the silicon-containing electrodes varied with varying prelithiation levels. The plots with higher prelithiation amounts show higher capacities.

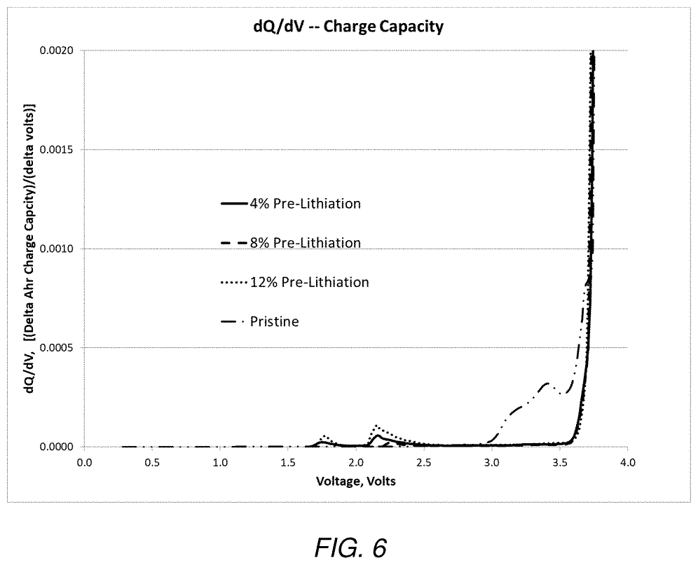

Referring to FIG. 6, the voltage of the sample silicon-containing electrodes was also plotted against the change in charge capacity divided by the change in voltage during a charging cycle. As can be seen from FIG. 6, the silicon-containing electrode that was not prelithiated shows reaction peaks between 3.0V and 3.8V. However, the prelithiated silicon-containing electrodes do not show these peaks. Without being bound by theory, it is believed that these peaks represent lithiation reactions, and that the prelithiated silicon-containing electrodes do not show such peaks because the reactions already occurred during the prelithiation process.

Various embodiments have been described above. Although the invention has been described with reference to these specific embodiments, the descriptions are intended to be illustrative and are not intended to be limiting. Various modifications and applications may occur to those skilled in the art without departing from the true spirit and scope of the invention as defined in the appended claims.

What is claimed is:

1. A method of prelithiating a silicon-containing electrode, the method comprising:
electrically connecting the silicon-containing electrode to a negative terminal of an electrical power source;
immersing the silicon-containing electrode in a lithium salt solution;
wherein a lithium source is immersed in the lithium salt solution such that it does not directly contact the silicon-containing electrode and the lithium source is electrically connected to a positive terminal of the electrical power source; and
applying a current from the electrical power source to the silicon-containing electrode for a duration until a desired level of lithium intercalation of the silicon-containing electrode is achieved.

2. The method of claim 1, wherein the silicon-containing electrode comprises a film comprising silicon and a carbon phase that holds the film together.

3. The method of claim 2, wherein the silicon-containing electrode further comprises silicon particles distributed within the carbon phase.

4. The method of claim 2, wherein the silicon-containing electrode further comprises a current collector, the film being in electrical communication with the current collector.

5. The method of claim 4, wherein the silicon-containing electrode is a rolled-type electrode.

6. The method of claim 5, wherein the silicon-containing electrode comprises and anode.

7. The method of claim 1, wherein applying the current from the electrical power source to the silicon-containing electrode results in a current density in the silicon-containing electrode of from about 0.05 mA/cm² to about 0.5 mA/cm².

8. The method of claim 1, wherein the lithium source comprises lithium metal.

9. The method of claim 8, wherein the lithium source comprises lithium metal foil.

10. The method of claim 1, wherein the lithium salt solution comprises an organic lithium salt solution.

11. The method of claim 10, wherein the lithium salt solution comprises Li trans-trans-muconate (ttMA).

12. The method of claim 1, wherein the method is carried out at room temperature.

13. The method of claim 1, wherein the method is carried out in an ambient atmosphere.

14. The method of claim 2, further comprising brushing the film and exposing the film to blowing air prior to immersing the silicon-containing electrode in the lithium salt solution.

15. The method of claim 1, further comprising subjecting the silicon-containing electrode to a post treatment process, wherein the post treatment process comprises rinsing the silicon-containing electrode with water and drying the rinsed silicon-containing electrode.

16. The method of claim 1, wherein substantially no lithium metal is plated or deposited on the silicon-containing electrode.

17. The method of claim 1, wherein the prelithiated silicon-containing electrode is used as a component in a lithium-ion electrochemical cell.

18. The method of claim 1, wherein the silicon-containing electrode is a Si-dominant electrode.

19. The energy storage device of claim 1, wherein the silicon-containing electrode comprises a self-supporting composite material film.

20. The energy storage device of claim 19, wherein the composite material film comprises:
greater than 0% and less than about 90% by weight of silicon particles, and
greater than 0% and less than about 90% by weight of one or more types of carbon phases, wherein at least one of the one or more types of carbon phases is a substantially continuous phase that holds the composite material film together such that the silicon particles are distributed throughout the composite material film.
